(19) United States
(12) Patent Application Publication
(10) Pub. No.: US 2018/0141610 A1
(43) Pub. Date: May 24, 2018

(54) REMOTE-CONTROLLED BRAKE FOR BICYCLES AND OTHER VEHICLES

(71) Applicants: MINIBRAKE KFT., Herend (HU); YVVOLVE SPORTS LTD., Dublin (IE)

(72) Inventors: Dániel Bognár, Telki (HU); Péter Szesztay, Herend (HU); Marcell Szirtes, Budapest (HU)

(73) Assignees: MINIBRAKE KFT., Herend (HU); YVVOLVE SPORTS LTD., Dublin (IE)

(21) Appl. No.: 15/531,456

(22) PCT Filed: Nov. 30, 2015
(86) PCT No.: PCT/EP2015/078112

§ 371 Date: May 29, 2017

(30) Foreign Application Priority Data
Nov. 28, 2014 (HU) P1400562

(51) Int. Cl. B62K 23/02; B62L 3/02; B60T 7/08; B62L 1/04; B62L 1/00

(52) U.S. Cl. CPC B62K 23/02; B62L 3/02; B62L 1/005; B62L 1/04; B60T 7/085

(57) ABSTRACT

In an aspect, a remote-controlled brake for a human-powered vehicle is provided and includes a support structure that is mountable to a frame of the vehicle, a shoe that is pivotable between a braking position and a non-braking position, a motor, and a local controller. In the braking position the shoe is abutted with a wheel of the vehicle to stop forward rolling of the wheel, while permitting backward rolling of the vehicle. In the non-braking position the shoe permits forward and backward rolling of the wheel. The motor is operatively connected to the shoe to move the shoe to and from both the braking and non-braking position. The local controller includes an electronic reception unit that is configured to receive signals from a remote controller, wherein the local controller is programmed to control operation of the motor based on the signals.

### CROSS-REFERENCE TO RELATED APPLICATIONS

This application claims the benefit of priority to Hungarian patent application P1400562, filed Nov. 28, 2014, the contents of which are incorporated herein in their entirety.

### FIELD OF DISCLOSURE

This disclosure relates generally to human-powered vehicles and more particularly to safety systems for children's bicycles.

### BACKGROUND OF DISCLOSURE

When teaching a child to ride a bicycle or other human-powered vehicle, there is a stage of such teaching where the child is sufficiently able to ride that they can leave the parent's immediate reach but are not sufficiently in control that they can avoid all obstacles or other dangers. As a result, there is the possibility that the child can drive into a dangerous intersection, for example, if they have not yet mastered braking, or if they are not aware of approaching cross-traffic, such that the parent has no way of preventing it.

Some remote-controlled braking systems have been proposed in the past, which permit the parent to remotely brake the bicycle so as to prevent such occurrences. However, some such systems suffer from certain deficiencies.

For example, in some systems, braking entails driving a shoe into engagement with a tire of one of the bicycle wheels. However, it can occur (especially in case of insufficiently inflated tires) that the shoe becomes wedged into the tire whereby such wedging causes excessive deformation that is beyond the extent required for braking, which can result in too much force which can harm the tire and the braking device.□ A further disadvantage is that following the braking process the shoe in the wedged position has to be reset to its original home position by hand. It can happen that this manual resetting of the shoe does not position the shoe properly, which can result in unintended braking by the shoe when no braking command was transmitted to the braking device, or non-actuation of the shoe when a braking command is received.

It would be beneficial to provide a remote-controlled brake for children's bicycles and vehicles, which at least partially mitigates the problems noted above.

### SUMMARY

In an aspect, a remote-controlled brake for children's bicycles and vehicles is provided, which can be mounted on the structure of children's vehicles and which contains a shoe that presses against the one of the vehicle's wheels, but which can be adjusted to inhibit damage to the tire and the braking device during actuation. The brake includes an electronic reception unit that is operated by a remote controller. The brake may have a hydraulic arrangement that holds the shoe and that drives the shoe as a consequence of the signal received from the remote controller.

In an aspect, a brake is provided for a children's bicycle, which is able to move a brake shoe in two directions (both towards and away from a braking position), and is able to avoid excessive wedging of the shoe thereby making the braking process possible with appropriate safety. Beyond the above mentioned advantages, the invention optimizes the mechanical support structure as far as size and costs are concerned.□ In order to provide a solution to the above challenge, we created a remote-controlled brake for children's bikes and for vehicles designed for children which can be adjusted and mounted on the vehicle's steel structure and that contains a shoe that presses on the vehicle's wheel to be braked, an electronic reception unit that can be operated with a remote controller, the tilting structure holding the shoe, the tilting motion of which is induced by the signal received from the remote controller, and the tilting shackle constituting the tilting structure around the knuckle which is linked through a flexible element to the motor operated by the electronic signal reception unit and the motor moves the tilting shackle towards the wheel to a great angle which is limited but sufficient for moving the tilting shackle with a certain speed to set the shoe in a braking position and at the end of the track of the movement towards the tilting shackle there is an anti-collision element preventing excessive pressure by the shoe but allowing sufficient force to enable the braking process.□ The brake solution constructed this way really solves the problem since power-driven movement is reliable and comfortable in both directions and at the same time the appropriate collision prevents excessive deformation of the braked tire.

By way of moving the power driven motor (e.g. a pacer or servo motor) driven shoe we can prevent the sudden wedging of the shoe to the wheel and the disadvantages described above can be avoided. Gradual braking makes it possible to provide a smooth transition and the curve of force increase becomes less steep□ In case of an advantageous design the motor moves on a turnable plate and is joined to the tilting shackle through a fibre spring, this link is not self-enclosing, that is, the tilting shackle can be moved away from the wheel by hand following the operation of the motor.

It is favourable for the structural design to create a T-profile support for this brake, where one of the ends is bent to both sides and can be linked to the bike structure and can be released at any time, the top of the T-profile is relatively horizontal, the collision plate at the back of the bike structure and on the vertical structure or in the surroundings there is a longitudinal gap on the majority of the shaft, the vertical shaft of the support structure being surrounded by the upper section of the U-profile support shackle (closed at the bottom) at both sides of which the upper edge is supported by the collision plate, and where the upper part of the support shackle which is near the structure continues in an almost vertical stem, there is borehole a at the upper section of the support shackle, and through this a fixing screw is mounted which has the task of setting the position of the support shackle, and the tilting shackle is joined to the stems of the support shackle through knuckles.

Moreover, it constitutes an advantage if a slanted motor support plate is joined to one of the sides of the support shackle which is placed at a distance from the side of the support shackle which makes it possible to allow free movement for the tilting shackle and the motor is mounted on the motor plate with the plate facing backwards and almost parallel to the level of the support shackle.□ The tilting shackle is practically composed of two plates linked together and having a gap between each other, the gap is loosely adjusted to the width of the support shackle and surrounds it, there is a borehole at one of the ends of the tilting shackle which can be linked with the borehole at the stem of the support shackle allowing the tilting movement, and at the opposite end of the plates where the boreholes are positioned there is an inlay linking the plates, the shoe is linked to the inlay with a joint that can be released.□ Moreover, it is favourable if a moving plate reaching out sideways is joined to the shaft of the motor and if there is a facilitating gap at the middle part of the tilting shackle and the flexible element is constituted by a fibre spring, one end of which is linked to the facilitating gap, the other into the end of the moving plate.

In case of a favourable design, the plates of the tilting shackle are linked together with a peg in the middle range which limits the tilting track of the tilting shackle through the collision to the front edges of the support shackle's stems.

In case of a further model, the children's bike brake has a two-part casing that covers the appliance at the sides and can be fixed to the support shackle at the sides. In case of this design, the electronic signal reception unit launching the operation of the motor is placed on the opposite side of the motor, the communication between them is established through a remote controller.□ The invention provides a solution to the challenges and tasks set by the brake, fosters a safe braking process, it is easy to handle, its structural design is optimal.□

In another aspect, a remote-controlled brake for a human-powered vehicle is provided and includes a support structure that is mountable to a frame of the vehicle, a shoe that is pivotable between a braking position and a non-braking position, a motor, and a local controller. In the braking position the shoe is abutted with a wheel of the vehicle to stop forward rolling of the wheel, while permitting backward rolling of the vehicle. In the non-braking position the shoe permits forward and backward rolling of the wheel. The motor is operatively connected to the shoe to move the shoe to and from both the braking and non-braking position. The local controller includes an electronic reception unit that is configured to receive signals from a remote controller, wherein the local controller is programmed to control operation of the motor based on the signals.

In yet another aspect, a remote-controlled brake for a human-powered vehicle, which includes a support structure that is mountable to a frame of the vehicle, a shoe that is pivotable between a braking position and a non-braking position, a motor and a local controller. In the braking position the shoe is abutted with a wheel of the vehicle to stop forward rolling of the wheel. In the non-braking position the shoe permits forward and backward rolling of the wheel. The motor is operatively connected to the shoe to move the shoe between the braking and non-braking position. The local controller includes an electronic reception unit that is programmed to receive signals from a remote controller, wherein the local controller is programmed to control operation of the motor, wherein the electronic reception unit is programmed to operate the motor to move the shoe to the braking position in at least one event selected from the events consisting of: a determination by the electronic reception unit that a distance between the electronic reception unit and the remote controller exceeds a selected range; a battery on the remote-controlled brake for powering the motor falls below a selected battery level; and a selected amount of interference occurs between the electronic reception unit and the remote controller.

### BRIEF DESCRIPTION OF DRAWINGS

The foregoing and other aspects of the disclosure will be more readily appreciated by reference to the accompanying drawings, wherein:

FIG. 1 is an exploded perspective view of components of a remote-controlled brake for a vehicle, in accordance with an embodiment of the present disclosure, including a support structure, a support shackle and a tilting shackle;

FIG. 2 is a perspective view of the support structure shown in FIG. 1;

FIG. 3 is a perspective view the tilting shackle shown in FIG. 1;

FIG. 4 is a top view of the tilting shackle shown in FIG. 1;

FIG. 5 is a perspective view of the support shackle shown in FIG. 1;

FIG. 6 is a side view of the component shown in FIG. 1 assembled together;

FIG. 7 is a front view of the assembled components shown in FIG. 6;

FIG. 8 is a side view of the remote-controlled brake mounted on a bicycle; and

FIG. 9 is a side view showing an alternative tilting shackle.

### DETAILED DESCRIPTION

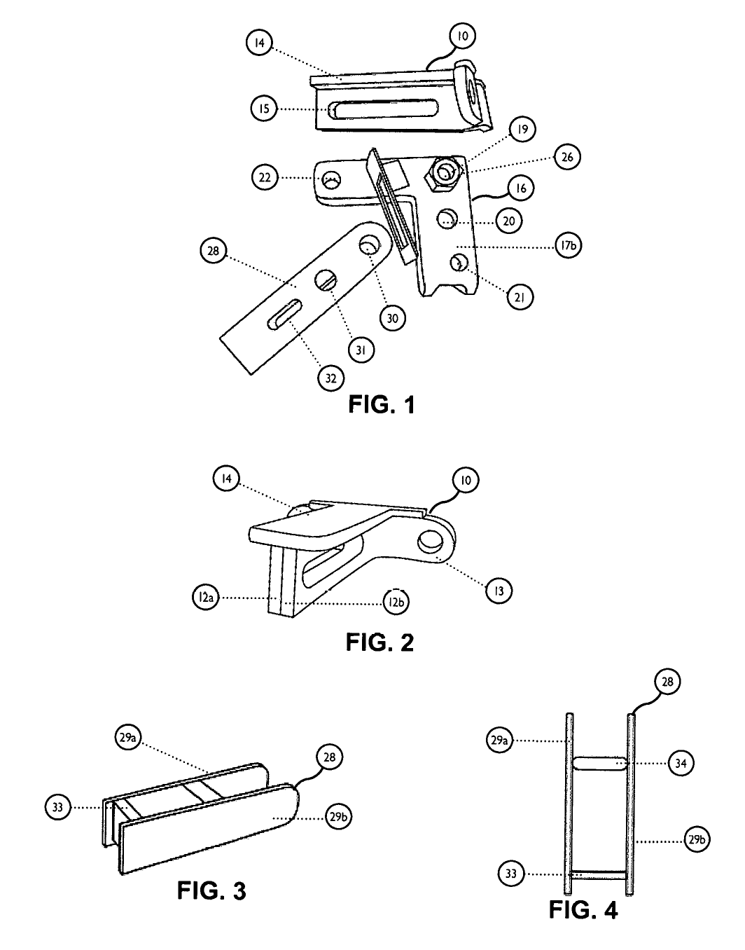

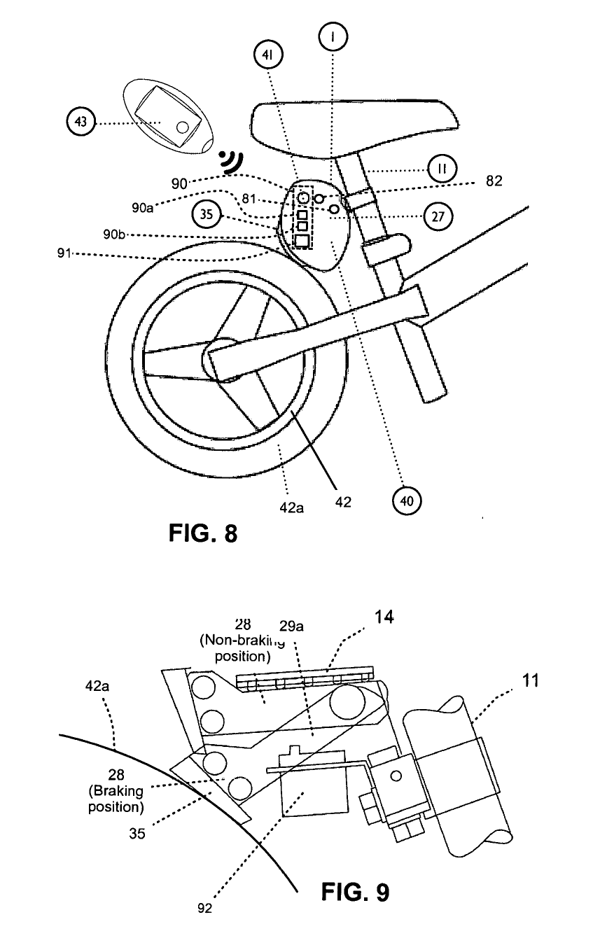

FIG. 1 is a magnified exploded view of some elements of a remote-controlled brake (1) (which may also be referred to in some embodiments as a child's bike brake, depending on the particular application it is used for). The brake 1 includes a support structure (10) that mounts to a suitable portion (e.g. a seat post 11 shown in FIG. 8) of a frame of a human-powered vehicle 85, such as a bicycle. □A perspective view of the support structure (10) in isolation is shown in FIG. 2. In order to increase rigidity the support structure (10) is composed of two rectangular plates (12a and 12b) placed next to each other and joined by spot welding, whose ends (13) are designed in a slightly slanted position, forming a slight angle relative to a perpendicular plane to the mating portions of the plates 12a and 12b, in order to facilitate mounting the brake on the seat post 11 which is not-quite vertical, with a yoke. In order to achieve rigidity, a strengthening plate (14) above the plates is mounted on the mating part of the two plates (12a and 12b), fixed to them by 30 welding. The strengthening plate 14 assists in providing appropriate rigidity. There is a longitudinal, narrow gap (15) running on the straight part of the plates (12a and 12b) which makes it possible to adjust the distance between the children's bike brake and the steel structure (11).

A support shackle (16) is presented in FIG. 5. The body of the support shackle (16) is composed of two stems (17a and 17b) forming a U-shape, having a gap between them and which continue in almost perpendicular sections (18a, 18b). The distance between the two stems (17a and 17b) and the two sections (18a and 18b) is practically equal to the collective width of the support structure (10) at the plates (12a, 12b), and in an installed state the sections (18a, 18b) surround the almost level plates (12a, 12b) of the support structure (10), with their upper edge bordered by the perpendicular strengthening element (14), as noted above, prevents their unintended movement. In FIG. 1 it can be seen that there are three boreholes (19, 20, 21) on the almost vertical stem (17b) of the support shackle (16) positioned below each other, and there is one borehole (22) at the end of the stems (17a and 17b).□ There is a motor support plate (23) that is fixed to the side (b) of the support shackle (16) at an angle via spot welding or any other appropriate means. This plate 23 may be generally L shaped. There is a rectangular aperture (24) on the plate 23 that is perpendicular to the stems (17a, 17b) where a motor 25 (e.g. a pacer or servo motor) illustrated in FIGS. 6 and 7 can be mounted. The force emerging at braking does not impact the motor support plate (23). □A fixing screw (26) can be placed in the upper borehole (19) as illustrated in FIG. 1, and when this screw is loosened, the support shackle (16) can be moved forward and backward in the range allowed by the gap (15), by tightening the screw 26 any kind of position can be fixed in a stable state. This arrangement is simple and easy to use, yet retains good stability as the fixing screw (26) holds the positioning of the support shackle (16), but also prevents the bending by the upper edges and the collision plate (14) pushing against each other in a stable way, transmitting force between the two components.

Two links 81 and 82 (e.g. rivets or screws) can be fixed in each of the boreholes 21 and 22 in the side 30 direction (not illustrated in the drawing) by pinning or brimming, their task is to hold the casing (27) covering the structure in position (FIG. 8).

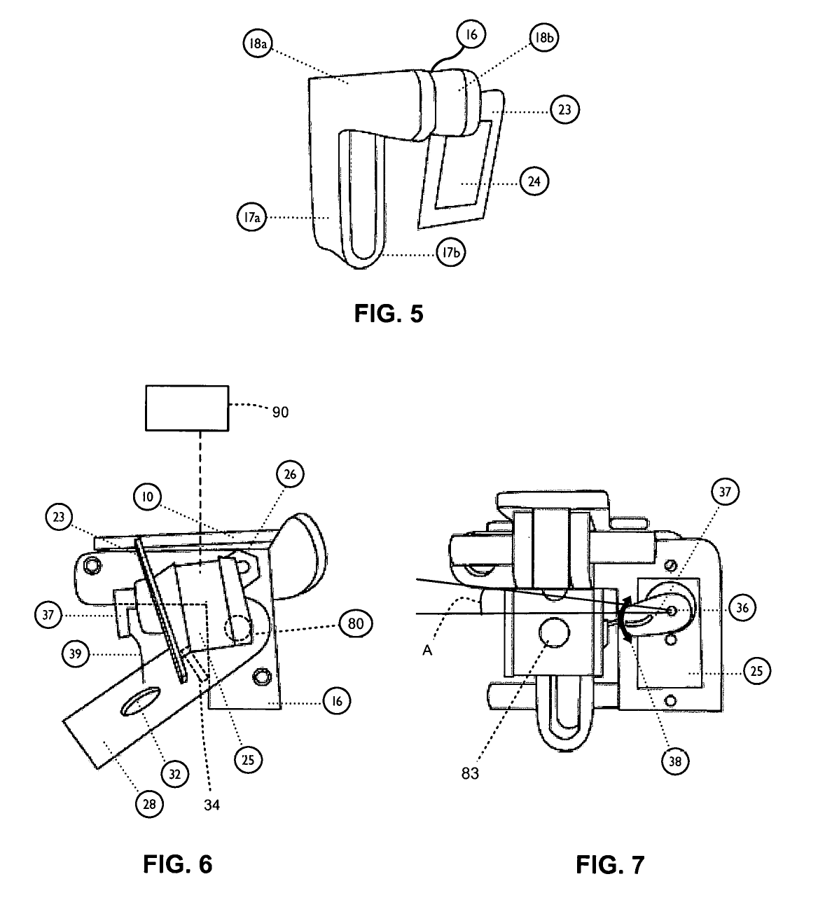

A third support structure of the remote-controlled brake (1) is the tilting shackle (28), an example of which is presented in FIGS. 3 and 4. The tilting shackle 28 may be made up of two identical plates (29a, 29b) linked to each other by spacers 33 and 34.

The space created this way loosely fits the distance between the external plates forming the support shackle (16). In other words, the tilting shackle 28 can be placed on the support shackle (16) from the outside. There are two boreholes (30, 31) and a facilitator (32) on the tilting shackle (28) as illustrated in FIG. 1. When assembling the brake 1, the borehole (30) covers the borehole (20) of the support shackle (16), and the tilting shackle (28) and the support shackle (16) can be linked together with a screw 80 (FIG. 6) in such a way that the link (i.e. screw 80) takes over the forces impacting the tilting shackle (28), however, at the same time the tilting shackle (28) can be turned around the screw 80, as a knuckle point in a certain angle. It will be noted that the plate 23 that holds the motor 25 will depart from the support shackle (16) to the required extent so that it does not interfere with the tilting motion of the tilting shackle (28).□ It can be seen in FIGS. 3 and 4 that the plates 29a, 29b of the tilting shackle (28) are linked and joined into one rigid component by the spacers 33 and 34, which may be referred to individually as an inlay (33) connecting the ends positioned far from the knuckle point and the peg (34) fitted into the borehole (31) in the middle section. The spacers 33 and 34 mentioned above have an additional role other than linking together the plates 29a and 29b. The peg (34) sets the lower limit for the tilting motion of the tilting shackle (28) since the peg 34 bumps into the front edges of the stems (17a, 17b) of the support shackle (16) (as shown in FIG. 6). There is a connector 83 (e.g. a threaded borehole or any other suitable means for connecting) in the middle of the inlay (33) and the external shoe (35) of the children's bike brake (1) can be fixedly but adjustably attached to this (FIG. 8) via a threaded fastener (e.g. a screw). In an alternative construction, the tilting shackle 28 may be as shown in FIG. 9, whereby the shoe 35 is connected to the tilting shackle 28 by means of fasteners that pass perpendicularly to the length of the tilting shackle 28, through at least one wall 29a. It will be noted that in FIG. 9, the tilting shackle 28 is shown in both the non-braking position and the braking position. In FIG. 8 it is shown in the braking position.

The assembly of the structural components of the brake (1) are presented in FIGS. 6 and 7. The side-view of FIG. 6 presents the assembled image of the three main structural components described above, namely the support structure (10), the support shackle (16) and the tilting shackle (28), where the support structure (10) and the surrounding support shackle (16) are fixed in the appropriate position by the fixing screw (26) and the tilting shackle (28) is pivotably mounted to the support shackle (16) in a turnable position. In FIG. 6 the tilting shackle (28) can be seen in the braking position, wherein the element 34 engages the edges of the walls 17a and 17b. By providing this engagement, the edges of the walls 17a and 17b act as a limiter for the tilting shackle and therefore limit the amount of engagement that is permitted between the shoe 35 and the wheel 42 of the vehicle 85 (FIG. 8). In FIG. 6 the motor (25) is shown mounted on the motor support plate (23) where there is a moving plate (37) mounted on a shaft 36 of the motor 25. The moving plate (37) can be turned around the shaft (36) of the motor (25) in accordance with the double arrow 38, in both directions within a certain angle (A). In other words, there is lost motion in the movement of the plate 37 such that movement of the plate 37 can occur without rotation of the motor shaft 36, within a selected angle A from whatever rest position the motor shaft 36 is at. The angle A may be any suitable angle and may depend on the specific details of the application.

At the end of the moving plate (37) there is a fibre spring (39) (e.g. an elastomeric elongate member) hooked into a small borehole on the moving plate 37 and the other end of the fibre spring 39 connects to the tilting shackle 28 (e.g. the other end may fit into the longitudinal borehole (32) of the tilting shackle (28)). The motor (25) moves in the direction of the arrow 38 up or down as a result of the appropriate instruction from a local controller 90 (FIG. 8). The local controller 90 includes an electronic reception unit (41) that is configured to receive signals from a remote controller 43, and is programmed to control operation of the motor based on the signals.

The local controller 90 includes a processor 90a and a memory 90b, which communicate with an electronic reception unit 41 as described further below. As a result, movement of the shaft of the motor (25) and the moving plate (37) is not self-closing. In other words, the moving plate (37) can be lifted by an external force and the motor (25) does not interfere with that, only slightly brakes it. The operation of the motor (25) turns the plate (37) up or down and this turns the tilting shackle (28) through a fibre spring (39) around the knuckle point up or down. The above mentioned mechanical torque is evidently greater than that is required for the turning of the tilting shackle (28).

The casing 40 (also referred to as a housing 40) shown in FIG. 8 may be formed from two halves that surround the arrangement shown in FIGS. 6 and 7. Additionally, the local controller 90 fits in the casing 40 which includes the electronic reception unit 41 and a battery 91 or other energy storage device on the opposite side of the motor (25). The casing halves may be fixed together by screws and may be fixed to the support shackle 16 as described above.

In FIG. 8 the brake (1) can be seen in a braking position, when the shoe (35) touches the tire (42) of the vehicle. There is a wireless connection between the electronic reception unit (41) and the remote controller (43) as long as the remote controller (43) is within the reception range of the reception unit 41. The range is preferably selected to be sufficient to cover a suitable distance for the safe supervision of the child. In some embodiments, the range may be selectable so that a particular seller of the brake 1 can select what range they find to be suitable. In other embodiments, the range may be selectable by the end user so that a parent can determine what range they are comfortable with depending on the child's capability, and/or depending on the particular environment the child is riding in.

In a default setting the shoe (35) and the tilting shackle (28) are at their uppermost or most distal position from the wheel 42 of the vehicle. During installation of the brake 1 on the vehicle, the support structure 10 may be positioned on the frame 11 and the support shackle 16 may be positioned on the support structure 10 such that in the braking position for the tilting shackle (28), the shoe (35) presses against the tire (shown at 42a) of the wheel 42, with a suitable pressure to stop forward rolling of the wheel 42. It will be noted, however, that, as can be seen in FIG. 8 particularly, the position of the pivot point of the tilting shackle 28 in combination with one or both of the lost motion in the movement of the moving plate 37 of the motor 25 and the presence of the spring 39 acting between the moving plate 37 and the tilting shackle 28) permit backward rolling of the wheel 42. Also, one or both of the lost motion in the movement of the moving plate 37 of the motor 25 and the presence of the spring 39 permit the rider of the vehicle to lift the shoe 35 off the wheel 42 at least temporarily so as to permit the rider to roll forwards if necessary to avoid a particular danger. The braking position for the shoe 35 and the tilting shackle 28 may be selected so that the shoe 35 engages and stops forward rolling of the wheel 42 even in a situation where there is relatively low air pressure in the tire 42a.

When the tilting shackle 28 is in the distal (non-braking) position, the wheel 42 is permitted to roll forwards and backwards.

If the parent holding the remote controller (43) realizes some kind of danger, he or she can operate the remote controller (43) to send a braking command to the local controller 90, which is received by the electronic reception unit (41). Upon receipt of the instruction, the local controller 90 may set the motor (25) in motion and through the fibre spring (39) the tilting shackle (28) is moved downwards with a certain speed to bring the tilting shackle 28 and the shoe (35) to the braking position at which the shoe 35 engages the tire (42a). Upon engagement, the direction of rotation of the wheel 42 causes greater engagement of the wheel 42 and the shoe 35 (a wedging action) until a latching or braking force emerges between the shoe (35) and the tire (42a) until the vehicle stops. The limiter, however, prevents the tilting shackle 28 from pivoting so much that the shoe 35 wedges so deeply into the tire 42a that the tire can 42 can become damaged. In other words, the tilting shackle 28 is prevented from damaging the tire from overengagement due to the aforementioned wedging action.

Safe operation can be ensured with appropriate codes and protection against faulty signals.

The motor 25 may be bidirectional and so, after the braking event, the parent can operate the remote controller (43) to send a signal to the local controller 90 to drive the motor (25) to lift the shoe (35) and move the shoe 35 and the tilting shackle 28 to the non-braking position (thereby removing the shoe 35 from the tire (42a)) thereby permitting the vehicle to be driven by the child again.

The local controller 90 may include a position sensor 92 (or may simply detect a spike in the current to the motor (25) when the tilting shackle reaches the distal most position and abuts something) at which point the local controller 90 can record that the motor 25 has driven the shoe 35 and the tilting shackle 28 to the non-braking positions. Thus it will be noted that the motor 25 is used to drive the shoe 35 to and from both the braking and the non-braking positions.

In some embodiments, the local controller 90 is programmed to control operation of the motor 25 to move the shoe to the braking position in at least one event selected from the events consisting of: a determination by the electronic reception unit that a distance between the electronic reception unit and the remote controller exceeds a selected range; a battery on the remote-controlled brake for powering the motor falls below a selected battery level; and a selected amount of interference occurs between the electronic reception unit and the remote controller. The selected range may be a range in between, for example, 10 m and 200 m. In some embodiments, the remote controller 43 may be programmed to transmit a selected number of signals to the electronic reception unit 41 over a selected period of time (e.g. 8 signals per second). The local controller 90 may be programmed to operate the motor to move the shoe 35 to the braking position upon receipt of less than a selected lower threshold number of signals over the selected period of time.

The embodiments of the children's bike brake 1 provides a safe braking process since the shoe (35) is pressed against the wheel (42) appropriately by the motor (25) and the peg (34) and limiter prevents the shoe (35) from pressing too heavily against the tire 42a. The described configuration has a relatively low number of components and a simple manufacturing process, while still providing a large force due to the wedging action, and while being resistant to static and dynamic wear. Additionally, the brake 1 is easy to mount and easy to adjust.

Those skilled in the art will understand that a variety of other modifications may be effected to the embodiments described herein without departing from the scope of the appended claims.

1. A remote-controlled brake for a human-powered vehicle, comprising:
a support structure that is mountable to a frame of the vehicle;
a shoe (35) that is pivotable between a braking position and a non-braking position, wherein in the braking position the shoe is abutted with a wheel of the vehicle to stop forward rolling of the wheel, while permitting backward rolling of the vehicle, and wherein in the non-braking position the shoe permits forward and backward rolling of the wheel;
a motor that is operatively connected to the shoe to move the shoe to and from both the braking and non-braking position; and
a local controller including an electronic reception unit (41) that is configured to receive signals from a remote controller, wherein the local controller is programmed to control operation of the motor based on the signals.

2. A remote-controlled brake as claimed in claim 1, further comprising a limiter that is positioned to limit engagement of the shoe and the wheel when the shoe is in the braking position.

3. A remote-controlled brake as claimed in claim 1, further comprising a spring through which the motor is operatively connected to the shoe, wherein the spring permits a rider to manually disengage the shoe from the wheel.

4. A remote-controlled brake as claimed in claim 2, wherein the position of the limiter is adjustable.

5. A remote-controlled brake as claimed in claim 1, wherein the shoe is positioned to engage a radially outer edge of a tire on the wheel.

6. A remote-controlled brake as claimed in claim 1, wherein the local controller is programmed to operate the motor to move the shoe to the braking position in the event that the distance between the electronic reception unit and the remote controller exceeds a selected range.

7. A remote-controlled brake for a human-powered vehicle, comprising:
a support structure that is mountable to a frame of the vehicle;
a shoe (35) that is pivotable between a braking position and a non-braking position, wherein in the braking position the shoe is abutted with a wheel of the vehicle to stop forward rolling of the wheel, and wherein in the non-braking position the shoe permits forward and backward rolling of the wheel;
a motor that is operatively connected to the shoe to move the shoe between the braking and non-braking position; and
a local controller that includes an electronic reception unit (41) that is programmed to receive signals from a remote controller, wherein the local controller is programmed to control operation of the motor to move the shoe to the braking position in at least one event selected from the events consisting of: a determination by the electronic reception unit that a distance between the electronic reception unit and the remote controller exceeds a selected range; a battery on the remote-controlled brake for powering the motor falls below a selected battery level; and a selected amount of interference occurs between the electronic reception unit and the remote controller.

8. A remote-controlled brake as claimed in claim 7, wherein the at least one event includes a determination by the electronic reception unit that a distance between the electronic reception unit and the remote controller exceeds a selected range, and wherein the range is selectable.

9. A remote-controlled brake as claimed in claim 8, wherein the range is selectable between a range of about 10 metres and about 200 metres.

10. A remote-controlled brake as claimed in claim 7, wherein the remote controller is programmed to transmit a selected number of signals to the electronic reception unit over a selected period of time and wherein the local controller is programmed to operate the motor to move the shoe to the braking position upon receipt of less than a selected lower threshold number of signals over the selected period of time.

11. A remote-controlled brake as claimed in claim 7, wherein the local controller is further programmed to emit at least one output in the event that the local controller determines that a failure has occurred with a component of the remote-controlled brake, wherein the at least one output is selected from the group of outlets consisting of audio output, visual output, and movement of the shoe to the braking position.

12. A remote-controlled brake for children's bikes and for vehicles designed for children which can be adjusted and mounted on the vehicle's steel structure (11) and that contains a shoe (35) that presses on the vehicle's wheel (42) to be braked, an electronic reception unit (41) that can be operated with a remote controller (43), the tilting structure holding the shoe (35), the tilting motion of which is induced by the signal coming from the remote controller (43), and characterized by the tilting shackle (28) constituting the tilting structure around the knuckle which is linked through a flexible element (39) to the motor (25) operated by the electronic signal reception unit (41) and the motor (25) moves the tilting shackle (28) towards the wheel (42) to a certain angle which is limited but sufficient for moving the tilting shackle (28) with a certain speed to set the shoe (35) in a braking position and at the end of the track of the movement towards the tilting shackle there is an anti collision element preventing excessive pressure by the shoe (35) but allowing sufficient force to enable the braking process, characterized by the fact that the motor (25) is connected to tilting shackle (28) through a turnable moving plate (37) wherein the flexible member is a fibre spring (39).

13. A remote-controlled brake as claimed in claim 12, further comprising a T-profile support structure (10) having an end that can be linked to the steel structure (11) of the bike, it is bent from the design at the sides, there is a collision plate extending rearwardly, the T-profile has a top that is generally horizontal and there is a gap stretching extending along the longitudinal part of the support structure (10), the vertical part of the support structure (10) is surrounded by the upper part (18a, 18b) of a narrow, U-profile supporting shackle (16) at both sides that is closed at the bottom, where the upper part (10) is supported by the collision plate (14) and the upper part of the support shackle (16) near the streel structure of the bike continues in almost perpendicular stems (17a, 17b) and at the upper section (18a, 18b) of the support shackle (16) there is a borehole (19) and through this and the borehole (15) of the support structure (10) a fixing screw (26) is mounted which has the task of setting the position of the support shackle (16), and the tilting shackle (28) is joined to the stems (17a, 17b) of the support shackle through knuckles.

14. A remote-controlled brake as claimed in claim 13, characterized by the fact that at one of the sides a bent position motor holding plate (23) is joined to the support shackle (16) which is set at a distance from the side of the support shackle (16) which makes it possible for the tilting shackle (28) to move freely on the tilting track and where the motor (25) is mounted on the motor holding plate (23), its shaft is facing backwards and it is more or less parallel to the level of the support shackle (16).

15. A remote-controlled brake as claimed in claim 14, characterized by the fact the tilting shackle (28) is composed of two plates (29a, 29b) linked together and separated by a space, where the space is loosely adjusted to the width of the support shackle (16) and surrounds it, and there is a borehole (30) at one of the ends of the tilting shackle (28) which can be linked through the borehole (20) on the stems (17a, 17b) of the support shackle allowing enough tilting movement and there is an inlay (33) connecting the plates (19a, 19b) at the opposite side of the borehole (30) and the shoe (35) is joined to the inlay (33) with a joint that can be released.

16. A remote-controlled brake as claimed in claim 15, characterized by the fact that a moving plate (37) stretching out at the sides is linked to the shaft of the motor (25), there is a facilitator (32) gap at the middle range of the tilting shackle (28), the flexible component is constituted by a fibre spring (39) of which one of the ends is linked to the facilitator gap (32) and the other to the end of the moving plate (37).

17. A remote-controlled brake as claimed in claim 15, characterized by the fact that the plates (29a, 29b) of the tilting shackle (28) are joined with a peg (34) in the middle range (34) which limits the tilting track of the tilting shackle's (28) front part through the collision of the stems (17a, 17b) of the support shackle (16).

18. A remote-controlled brake as claimed in claim 13 characterized by that the brake has a casing which can be fixed to the support shackle (16) at the sides and which covers the structure at both sides, the casing (40) being composed of two parts where there is space provided for an electronic reception unit (41) which communicates with the remote controller wireless, through a remote controller (43).
